(19) United States
(12) Patent Application Publication
(10) Pub. No.: US 2014/0360369 A1
(43) Pub. Date: Dec. 11, 2014

(54) PROCESS FOR THE ASBORPTION OF CO2 FROM A GAS MIXTURE WITH AN ABSORPTION MEDIUM COMPRISING AMINES

(71) Applicant: Evonik Degussa GmbH, Essen (DE)

(72) Inventors: Alexander Schraven, Issum (DE); Stefanie Rinker, Hunxe (DE); Benjamin Willy, Dusseldorf (DE); Jöm Rolker, Alzenau (DE); Rolf Schneider, Gründau-Rothenbergen (DE); Daniel Dembkowski, Essen (DE); Manfred Neumann, Marl (DE); Jochen Niemeyer, Munster (DE)

(73) Assignee: Evonik Degussa GmbH, Essen (DE)

(21) Appl. No.: 14/372,287

(22) PCT Filed: Nov. 30, 2012
(86) PCT No.: PCT/EP2012/074019

§ 371 Date: Jul. 15, 2014

(30) Foreign Application Priority Data
Jan. 16, 2012 (DE) 10 2012 200 566.8

(51) Int. Cl. B01D 53/14; C10L 3/10

(52) U.S. Cl. CPC B01D 53/1493; B01D 53/1475; B01D 53/1425; C10L 3/104; B01D 2252/2041; B01D 2252/20426; B01D 2252/20431
USPC 95/177; 95/236; 95/179

(57) ABSTRACT

An absorption medium comprising water and at least one amine of formula (I)

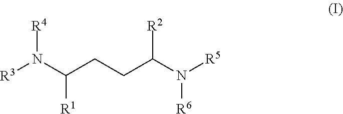

where
R² is hydrogen or an alkyl radical having 1 to 4 carbon atoms,
R² is an alkyl radical having 1 to 4 carbon atoms,
R³ and R⁵ are each independently alkyl radicals having 1 to 6 carbon atoms and
R⁴ and R⁶ are each independently hydrogen or alkyl radicals having 1 to 6 carbon atoms
where R³ and R⁴ may combine to form the bridging radical —(CH₂)ₙ—, —CH₂CH₂OCH₂CH₂— or —CH₂CH₂NR⁷CH₂CH₂— with n=2 to 5 and R²=hydrogen or an alkyl radical having 1 to 6 carbon atoms,
brings about an improved CO₂ absorption capacity in the absorption of CO₂ from a gas mixture by contacting the gas mixture with the absorption medium.

The invention relates to a process for absorbing CO₂ from a gas mixture.

Gas streams which have an undesirable high content of CO₂ which has to be reduced for further processing, for transport or for avoiding CO₂ emissions occur in numerous industrial and chemical processes.

On the industrial scale, CO₂ is typically absorbed from a gas mixture by using aqueous solutions of alkanolamines as an absorption medium. The loaded absorption medium is regenerated by heating, depressurization to a lower pressure or stripping, and the carbon dioxide is desorbed. After the regeneration process, the absorption medium can be used again. These processes are described for example in Rolker, J.; Arlt, W.; “Abtrennung von Kohlendioxid aus Rauchgasen mittels Absorption” [Removal of carbon dioxide from flue gases by absorption] in Chemie Ingenieur Technik 2006, 78, pages 416 to 424, and also in Kohl, A. L.; Nielsen, R. B., “Gas Purification”, 5th edition, Gulf Publishing, Houston 1997.

A disadvantage of these processes, however, is that the removal of CO₂ by absorption and subsequent desorption requires a relatively large amount of energy and that, on desorption, only a part of the absorbed CO₂ is desorbed again, with the consequence that, in a cycle of absorption and desorption, the capacity of the absorption medium is not sufficient.

Diamines, oligoamines and polyamines have been proposed as alternatives to alkanolamines in the prior art.

WO 2004/082809 describes absorption of CO₂ from gas streams using concentrated aqueous solutions of diamines of formula (R¹)₂N(CR²R³)ₙN(R¹)₂ where R¹ may be a C₁-C₄ alkyl radical and R² and R³ may each independently be hydrogen or a C₁-C₄ alkyl radical. For the case where n=4, the diamines tetramethyl-1,4-butanediamine and tetraethyl-1,4-butanediamine are explicitly disclosed. Diamines comprising two tertiary amino groups have the disadvantage that absorption of CO₂ proceeds slowly.

WO 2010/012883 describes the absorption of CO₂ from gas streams using an aqueous solution of N,N,N′,N′-tetramethyl-1,6-hexanediamine. In order to avoid phase separation into two liquid phases during absorption, it is further necessary, to add a primary or secondary amine to the absorption medium.

WO 2011/080405 describes the absorption of CO₂ from gas streams using aqueous solutions of diamines of formula R¹R²N(CR⁴R⁵)(CR⁶R⁷)ₐNHR³ where R¹ and R² may each independently be a C₁-C₁₂ alkyl radical or a C₁-C₁₂ alkoxyalkyl radical, R³ to R⁷ may each independently be hydrogen, a C₁-C₁₂ alkyl radical or a C₁-C₁₂ alkoxyalkyl radical, a=1 to 11 and R³ is different from R¹ and R². For the case where n=3, the diamine N1,N1-diethyl-1,4-pentanedamine is explicitly disclosed.

WO 2011/080406 describes the absorption of CO₂ from gas streams using aqueous solutions of triamines. The triamine N1,N1-diethyl-N4-dimethylaminoethyl-1,4-pentanediamine is disclosed as having an increased absorption capacity compared to ethanolamine and methyldiethanolamine.

It has now been found that, surprisingly, the amines of formula (I) provide an improved CO₂ absorption capacity compared to the amines known from WO 2004/082809 and WO 2011/080405 and heating in a subsequent desorption step provides a particularly low residual CO₂ content.

The invention accordingly provides a process for absorbing CO₂ from a gas mixture by contacting the gas mixture with an absorption medium comprising water and at least one amine of formula (I)

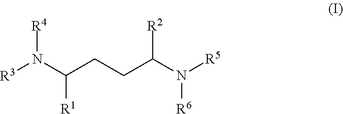

where
R¹ is hydrogen or an alkyl radical having 1 to 4 carbon atoms,
R² is an alkyl radical having 1 to 4 carbon atoms,
R³ and R⁵ are each independently alkyl radicals having 1 to 6 carbon atoms and
R⁴ and R⁶ are each independently hydrogen or alkyl radicals having 1 to 6 carbon atoms,
and R³ and R⁴ may combine to form the bridging radical —(CH₂)ₙ—, —CH₂CH₂OCH₂CH₂— or —CH₂CH₂NR⁷CH₂CH₂— with n=2 to 5 and R⁷=hydrogen or an alkyl radical having 1 to 6 carbon atoms.

The amines of formula (I) used in the process according to the invention are diamines in which the nitrogen atoms are separated by a chain of 4 carbon atoms which bears on at least one of the carbon atoms adjacent to the nitrogen atoms an alkyl radical having 1 to 4 carbon atoms. Both nitrogen atoms are further substituted with alkyl groups having 1 to 6 carbon atoms, so in each case a secondary or tertiary amino group is present. One of the two nitrogen atoms may also be part of a saturated heterocycle, for example of a pyrrolidine, piperidine, morpholine or piperazine.

The radicals R¹ and R² in formula (I) may be alkyl radicals having 1 to 4 carbon atoms, unbranched n-alkyl radicals being preferred. It is preferable to use amines of formula (I) in which the chain connecting the nitrogen atoms bears only one alkyl substituent, i.e., the radical R¹ in formula (I) is hydrogen. It is particularly preferable when the chain connecting the nitrogen atoms is substituted with a methyl group, i.e., the radical R² in formula (I) is methyl.

The radicals R³ to R⁶ in formula (I) may be cyclic or acyclic alkyl radicals having 1 to 6 carbon atoms, unbranched n-alkyl radicals being preferred. In a preferred embodiment, one of the two nitrogen atoms of the amine of formula (I) is a tertiary amine, i.e., the radical R⁴ in formula (I) is not a hydrogen atom. It is particularly preferable for the amine of formula(I) to comprise both a secondary and a tertiary amino group, i.e., the radical R⁶ in formula (I) is a hydrogen atom and the radical R⁴ in formula (I) is not a hydrogen atom. The tertiary nitrogen atom preferably bears two identical radicals R³ and R⁴, which, more preferably, are methyl or ethyl groups or combine with the nitrogen atom to form a morpholine ring i.e., R³ and R⁴ form the bridging radical —CH₂CH₂OCH₂CH₂—.

Particularly preferred amines of formula(I) are N1,N1,N4-trimethyl-1,4-diaminopentane, N1,N1-dimethyl-N4-ethyl-1,4-diaminopentane, N1,N1-dimethyl-N4-propyl-1,4-diaminopentane, N1,N1-diethyl-N4-methyl-1,4-diaminopentane, N1,N1,N4-triethyl-1,4-diaminopentane, N1,N1-diethyl-N4-propyl-1,4-diaminopentane, N-(4-methylamino)pentylmorpholine, N-(4-ethylamino)pentylmorpholine and N-(4-propylamino)pentylmorpholine.

Amines of formula(I) may be prepared according to known processes. In a first step, in accordance with equation (1), a nitroalkane is reacted with an α,β-unsaturated carbonyl compound in a Michael addition, as described in J. Am. Chem. Soc. 74 (1952) 3664-3668.

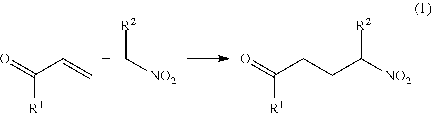

In a further step, in accordance with equation (2), a reductive amination with an alkylamine is carried out at the carbonyl group of the product from the first step, followed by reduction of the nitro group, for example as described in U.S. Pat. No. 4,910,343.

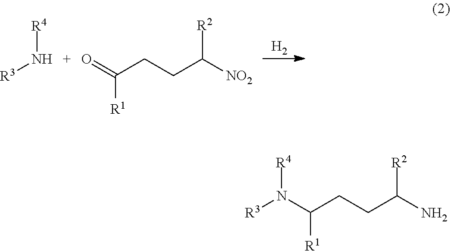

Substituents R⁵ and R⁶ may subsequently be introduced by further reductive amination, as shown in equation (3) for the introduction of R⁵=ethyl by reductive amination.

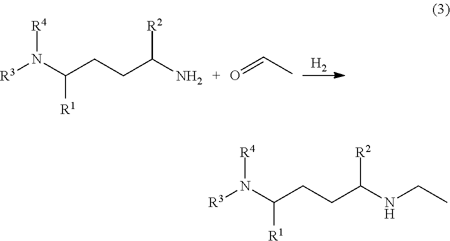

The working medium used in the process according to the invention comprises water and at least one amine of formula (I). The content of amines of formula (I) in the absorption medium is preferably 10 to 60 wt %, more preferably 20 to 50 wt %. The content of water in the absorption medium is preferably 40 to 80 wt %.

The absorption medium may, in addition to water and amines of formula (I), further comprise at least one sterically unhindered primary or secondary amine as an activator. A sterically unhindered primary amine for the purposes of the invention is a primary amine in which the amino group is bonded to a carbon atom which has at least one hydrogen atom bonded to it. A sterically unhindered secondary amine for the purposes of the invention is a secondary amine in which the amino group is bonded to carbon atoms each having at least two hydrogen atoms bonded to them. The content of sterically unhindered primary or secondary amines is preferably 0.1 to 10 wt %, more preferably 0.5 to 8 wt %. Suitable activators include activators known from the prior art, such as monoethanolamine, piperazine and 3-(methylamino)propylamine. The addition of an activator brings about an increase in the rate of absorption of CO₂ from the gas mixture without a loss of absorption capacity.

In addition to water and amines, the absorption medium may further comprise one or more physical solvents. The proportion of physical solvents in this case may be up to 50% by weight. Suitable physical solvents include sulfolane, aliphatic acid amides, such as N-formyl-morpholine, N-acetylmorpholine, N-alkylpyrrolidones, more particularly N-methyl-2-pyrrolidone, or N-alkylpiperidones, and also diethylene glycol, triethylene glycol and polyethylene glycols and alkyl ethers thereof, more particularly diethylene glycol monobutyl ether. Preferably, however, the absorption medium contains no physical solvent.

The absorption medium may additionally comprise further additives, such as corrosion inhibitors, wetting-promoting additives and defoamers.

All compounds known to the skilled person as suitable corrosion inhibitors for the absorption of CO₂ using alkanolamines can be used as corrosion inhibitors in the absorption medium of the invention, in particular the corrosion inhibitors described in U.S. Pat. No. 4,714,597. In the process of the invention, a significantly lower amount of corrosion inhibitors can be chosen than in the case of a customary absorption medium containing ethanolamine, since the absorption medium used in the method of the invention is significantly less corrosive towards metallic materials than the customarily used absorption media that contain ethanolamine.

The cationic surfactants, zwitterionic surfactants and nonionic surfactants known from WO 2010/089257 page 11, line 18 to page 13, line 7 are preferably used as wetting-promoting additive.

Defoamers that may be used in the absorption medium include any substances known to those skilled in the art as suitable defoamers for absorption of CO₂ using alkanolamines.

In the process according to the invention, the gas mixture may be a natural gas, a methane-containing biogas from a fermentation, composting or a sewage treatment plant, a combustion off-gas, an off-gas from a calcination reaction, such as the burning of lime or the production of cement, a residual gas from a blast-furnace operation for producing iron, or a gas mixture resulting from a chemical reaction, such as, for example, a synthesis gas containing carbon monoxide and hydrogen, or a reaction gas from a steam-reforming hydrogen production process. The gas mixture is preferably a combustion off-gas, a natural gas or a biogas, particularly preferably a combustion off-gas, for example from a power station.

The gas mixture can contain further acid gases, for example COS, H₂S, CH₃SH or SO₂, in addition to CO₂. In a preferred embodiment, the gas mixture contains H₂S in addition to CO₂. A combustion off-gas is preferably desulphurized beforehand, i.e. SO₂ is removed from the gas mixture by means of a desulphurization method known from the prior art, preferably by means of a gas scrub using milk of lime, before the absorption process of the invention is carried out.

Before being brought into contact with the absorption medium, the gas mixture preferably has a CO₂ content in the range from 0.1 to 50% by volume, particularly preferably in the range from 1 to 20% by volume, and most preferably in the range from 10 to 20% by volume.

The gas mixture can contain oxygen, preferably in a proportion of from 0.1 to 25% by volume and particularly preferably in a proportion of from 0.1 to 10% by volume, in addition to CO₂.

For the process of the invention, all apparatus suitable for contacting a gas phase with a liquid phase can be used to contact the gas mixture with the absorption medium. Preferably, absorption columns or gas scrubbers known from the prior art are used, for example membrane contactors, radial flow scrubbers, jet scrubbers, venturi scrubbers, rotary spray scrubbers, random packing columns, ordered packing columns or tray columns. With particular preference, absorption columns are used in countercurrent flow mode.

In the process of the invention, the absorption of CO₂ is carried out preferably at a temperature of the absorption medium in the range from 0 to 80° C., more preferably 20 to 70° C. When using an absorption column in countercurrent flow mode, the temperature of the absorption medium is more preferably 30 to 60° C. on entry into the column, and 35 to 70° C. on exit from the column.

The CO₂-containing gas mixture is preferably contacted with the absorption medium at an initial CO₂ partial pressure of from 0.01 to 4 bar. It is particularly preferable when the initial partial pressure of CO₂ in the gas mixture is from 0.05 to 3 bar. The total pressure of the gas mixture is preferably in the range from 0.8 to 50 bar, more preferably 0.9 to 30 bar.

In a preferred embodiment of the process of the invention, CO₂ absorbed in the absorption medium is desorbed again by increasing the temperature and/or reducing the pressure and the absorption medium after this desorption of CO₂ is used again for absorbing CO₂. The desorption is preferably carried out by increasing the temperature. By such cyclic operation of absorption and desorption, CO₂ can be entirely or partially separated from the gas mixture and obtained separately from other components of the gas mixture.

As an alternative to the increase in temperature or the reduction in pressure, or in addition to an increase in temperature and/or a reduction in pressure, it is also possible to carry out a desorption by stripping the absorption medium loaded with CO₂ by means of an inert gas, such as air or nitrogen.

If, in the desorption of CO₂, water is also removed from the absorption medium, water may be added as necessary to the absorption medium before reuse for absorption.

All apparatus known from the prior art for desorbing a gas from a liquid can be used for the desorption. The desorption is preferably carried out in a desorption column. Alternatively, the desorption of CO₂ may also be carried out in one or more flash evaporation stages.

The desorption is carried out preferably at a temperature in the range from 50 to 200° C. In a desorption by an increase in temperature, the desorption of CO₂ is carried out preferably at a temperature of the absorption medium in the range from 50 to 180° C., more preferably 80 to 150° C. The temperature during desorption is then preferably at least 20° C., more preferably at least 30° C., above the temperature during absorption. When desorption is effected by increasing the temperature, it is preferable to carry out stripping using steam generated by evaporating part of the absorbtion medium.

When desorption is effected by reducing the pressure, the desorption is preferably carried out at a pressure in the range from 0.01 to 10 bar.

Since the absorption medium used in the process according to the invention has a high CO₂ absorption capacity and is present in the processes according to the invention as a homogeneous solution, with no precipitation of a solid occurring on absorption of CO₂, the process according to the invention can be used in plants of a simple construction and, if so used, achieves an improved CO₂ absorption performance compared to the amines known from the prior art. At the same time, compared to ethanolamine, substantially less energy is required to desorb CO₂.

In a preferred embodiment of the process of the invention, the desorption is carried out by stripping with an inert gas such as air or nitrogen in a desorption column. The stripping in the desorption column is preferably carried out at a temperature of the absorption medium in the range from 60 to 100° C. Stripping enables a low residual content of CO₂ in the absorption medium to be achieved after desorption with a low energy consumption.

The following examples illustrate the invention without, however, limiting the subject matter of the invention.

### EXAMPLES

### Example 1

### Preparation of N1,N1,N4-triethyl-1,4-diaminopentane

Into a stirred autoclave were charged 52.9 g (1.20 mol) of acetaldehyde and 50 ml of methanol. Subsequently, 2.90 g of 10% palladium on activated carbon (water-moist), 130 ml of methanol and 196 g of N1,N1-diethyl-1,4-diaminopentane (1.20 mol) were added. The autoclave was sealed and pressurized to 40 bar with hydrogen. The mixture was heated from 40° C. to 100° C. over 5 h under a hydrogen atmosphere, further hydrogen being introduced to re-establish a pressure of 40 bar when the pressure in the autoclave fell below 20 bar. Subsequently, the catalyst was filtered off and, following distillative removal of the solvent, the residue was distilled. 135 g (0.724 mol, 60%) of N1,N1,N4-triethyl-1,4-diaminopentane were obtained as a colourless liquid.

### Example 2

### Preparation of N1,N1-diethyl-N4-propyl-1,4-diaminopentane

Example 1 was repeated except that 74.7g (1.26 mol) of propionaldehyde and 100 ml of methanol were charged, and 100 ml of methanol were subsequently added instead of 130 ml of methanol. 143 g (0.714 mol, 59%) of N1,N1-diethyl-N4-propyl-1,4-diaminopentane were obtained as a colourless liquid.

### Example 3

### Preparation of N1,N1-diethyl-N4-isopropyl-1,4-diaminopentane

Into a stirred autoclave were charged 105 g (1.80 mol) of acetone. Subsequently, 3.60 g of 10% palladium on activated carbon (water-moist), 180 ml of methanol and 245 g of N1,N1-diethyl-1,4-diaminopentane (1.50 mol) were added. The autoclave was sealed and pressurized to 40 bar with hydrogen. The mixture was heated from 40° C. to 120° C. over 8 h under a hydrogen atmosphere, further hydrogen being introduced to re-establish a pressure of 40 bar when the pressure in the autoclave fell below 20 bar. Subsequently, the catalyst was filtered off and, following distillative removal of the solvent, the residue was distilled. 260 g (1.30 mol, 87%) of N1,N1-diethyl-N4-isopropyl-1,4-diaminopentane were obtained as a colourless liquid.

### Examples 4 to 10

### Determination of CO₂ Absorption Capacity

For determining the CO₂ loading and the CO₂ uptake, 150 g of absorption medium composed of 30 wt % of amine and 70 wt % of water were charged to a thermostatable container with a top-mounted reflux condenser cooled at 3° C. After heating to 40° C. or 100° C., a gas mixture of 14% CO₂, 80% nitrogen and 6% oxygen by volume was passed at a flow rate of 59 l/h through the absorption medium, via a frit at the bottom of the container, and the CO₂ concentration in the gas stream exiting the reflux condenser was determined by IR absorption using a CO₂ analyser. The difference between the CO₂ content in the gas stream introduced and in the exiting gas stream was integrated to give the amount of CO₂ taken up, and the equilibrium CO₂ loading of the absorption medium was calculated. The CO₂ uptake was calculated as the difference in the amounts of CO₂ taken up at 40° C. and at 100° C. The equilibrium loadings determined in this way at 40° C. and 100° C., in mol CO₂/mol amine, and the CO₂ uptake in mol CO₂/kg absorption medium are given in Table 1.

TABLE 1

| | | Loading at | Loading at | |
|---|---|---|---|---|
| | | 40° C. in | 100° C. in | CO₂ uptake |
| Example | Amine | mol/mol | mol/mol | in mol/kg |
| 4* | Ethanolamine | 0.57 | 0.22 | 1.72 |
| 5* | Methyldiethanolamine | 0.38 | 0.05 | 0.82 |
| 6* | N1,N1,N4,N4-Tetramethyl-1,4-diaminobutane | 1.20 | 0.27 | 1.93 |
| 7* | N1,N1-Diethyl-1,4-diaminopentane | 0.96 | 0.30 | 1.24 |
| 8 | N1,N1,N4-Triethyl-1,4-diaminopentane | 1.99 | 0.17 | 2.93 |
| 9 | N1,N1-Diethyl-N4-propyl-1,4-diaminopentane | 2.04 | 0.25 | 2.68 |
| 10 | N1,N1-Diethyl-N4-isopropyl- | 1.76 | 0.27 | 2.23 |
| | 1,4-diaminopentane | | | |

*not according to the invention

1-10. (canceled)

11. A process for absorbing CO₂ from a gas mixture by contacting the gas mixture with an absorption medium, wherein the absorption medium comprises water and at least one amine of formula (I): 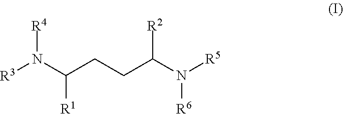
wherein:
R¹ is hydrogen or an alkyl radical having 1 to 4 carbon atoms,
R² is an alkyl radical having 1 to 4 carbon atoms,
R³ and R⁵ are each independently alkyl radicals having 1 to 6 carbon atoms, and
R⁴ and R⁶ are each independently hydrogen or alkyl radicals having 1 to 6 carbon atoms, and R³ and R⁴ may combine to form the bridging radical —(CH₂)ₙ—, —CH₂CH₂OCH₂CH₂— or —CH₂CH₂NR⁷CH₂CH₂— where n=2 to 5 and R⁷=hydrogen or an alkyl radical having 1 to 6 carbon atoms.

12. The process of claim 11, wherein R¹ in formula (I) is hydrogen.

13. The process of claim 11, wherein R² in formula (I) is a methyl radical.

14. The process of claim 11, wherein R⁴ in formula (I) is not hydrogen.

15. The process of claim 11, wherein the radicals R³ and R⁴ in formula (I) are both methyl or both ethyl or combine to form the bridging radical —CH₂CH₂OCH₂CH₂—.

16. The process of claim 11, wherein said absorption medium comprises amines of formula (I) in an amount of from 10 to 60 wt %.

17. The process of claim 11, wherein the gas mixture is a combustion off-gas, a natural gas or a biogas.

18. The process of claim 11, wherein CO₂ absorbed in the absorption medium is desorbed again by increasing the temperature and/or reducing the pressure and the absorption medium after this desorption of CO₂ is used again for absorbing CO₂.

19. The process of claim 18, wherein the absorption is carried out at a temperature in the range from 0 to 80° C. and the desorption is carried out at a higher temperature in the range from 50 to 200° C.

20. The process of claim 18, wherein the absorption is carried out at a pressure in the range from 0.8 to 50 bar and the desorption is carried out at a pressure in the range from 0.01 to 10 bar.

21. The process of claim 11, wherein said absorption medium comprises an amine of formula (I) selected from the group consisting of N1,N1,N4-trimethyl-1,4-diaminopentane, N1,N1-dimethyl-N4-ethyl-1,4-diaminopentane, N1,N1-dimethyl-N4-propyl-1,4-diaminopentane, N1,N1-diethyl-N4-methyl-1,4-diaminopentane, N1,N1,N4-triethyl-1,4-diaminopentane, N1,N1-diethyl-N4-propyl-1,4-diaminopentane, N-(4-methylamino)pentylmorpholine, N-(4-ethylamino)pentylmorpholine and N-(4-propylamino)pentylmorpholine.
